(19) United States
(12) Patent Application Publication
(10) Pub. No.: US 2014/0022795 A1
(43) Pub. Date: Jan. 23, 2014

(54) LED BULB

(71) Applicant: USHIO DENKI KABUSHIKI KAISHA, Tokyo-to (JP)

(72) Inventor: Akihisa MATSUMOTO, Hyogo (JP)

(21) Appl. No.: 13/943,289

(22) Filed: Jul. 16, 2013

(30) Foreign Application Priority Data
Jul. 18, 2012 (JP) 2012-159391

(51) Int. Cl. F21V 5/02

(52) U.S. Cl. CPC F21V 5/02
USPC 362/311.02

(57) ABSTRACT

An LED bulb including a light-emitting portion having an LED element as a light-emitting source, wherein the light-emitting portion includes an LED module having an LED substrate elongated in one direction and a plurality of the LED elements arranged so as to be arrayed in the longitudinal direction of the LED substrate on at least one of surfaces of the LED substrate, the LED module being incorporated in an optical member, and the optical member includes an optical functional portion configured to direct light in the direction of an extension of the LED substrate in the longitudinal direction thereof.

### BACKGROUND OF THE INVENTION

1. Technical Field

The present invention relates to an LED bulb provided with an LED element as a light-emitting source.

2. Description of the Related Art

In recent years, an LED bulb provided with an LED element as a light-emitting source with low power consumption now attracts attention instead of a lighting power source with high power consumption such as an incandescent filament lamp provided with a resistant heating-type filament as a light-emitting source. Specifically, an LED bulb formed to have substantially the same appearance as a general lighting incandescent filament lamp has been developed as the aforementioned LED bulb.

As to the LED bulb in such a type, due to the LED element being regarded as a light source having a high directivity, the LED bulb is desired to be capable of radiating light over a wide range such as those having a light distribution close to that of an incandescent filament lamp in order to enhance the utility.

For example, JP-A-2006-012824 discloses a technology for controlling light radiated from a light-emitting portion arrayed with a plurality of chip-like LED elements by using a light guide. Japanese Patent No. 4689762 discloses a technology for adjusting the light distribution of light radiated from an LED bulb by arranging a reflector configured to reflect light from chip-like LED elements arranged in a bulb body.

However, in the LED bulb of the related arts, cannot realize the desired light distribution in the direction of the entire circumference of the LED bulb as an actual condition.

### SUMMARY OF INVENTION

In view of such circumstances described above, it is an object of the invention to provide an LED bulb which is capable of irradiating a desired light distribution in the direction of substantially entire circumference.

The invention provides an LED bulb which comprises:

an optical member;

a light-emitting portion including:
an LED module incorporated in the optical member, said LED module having:
an LED substrate elongated in its longitudinal direction; and
a plurality of LED elements, as light-emitting sources, arranged on at least one of surfaces of the LED substrate so as to be arrayed in the elongated direction of the LED substrate;

wherein said optical member includes an optical functional portion configured to direct light in the longitudinal direction of the LED substrate.

Preferably, in the LED bulb of the invention, the optical functional portion of the optical member is formed so as to face a surface of the LED substrate on which the LED elements are mounted, and includes a first slant surface inclined so that an extension thereof intersects the direction of one of extensions of the LED substrate in the longitudinal direction thereof, and a second slant surface inclined so that an extension thereof intersects the direction of the other extension of the LED substrate in the longitudinal direction thereof.

In this configuration, the optical functional portion of the optical member is formed with a plurality of triangular prism-shaped portions each having two planes interposing an apex therebetween, the two planes being the first slant surface and the second slant surface, and the plurality of triangular prism-shaped portions being arranged in the longitudinal direction of the LED substrate.

In the LED bulb of the invention, the light-emitting portion includes two LED modules each including the LED substrate having a plurality of LED elements arranged on one surface thereof, and the two LED modules are arranged with the other surface of each of the LED substrates facing each other.

Alternatively, the LED modules may each include the plurality of LED elements arranged on each of both surfaces of the LED substrate.

According to the LED bulb of the invention, since the LED module is incorporated in the optical member having the optical functional portion configured to direct light in the direction of an extension of the LED substrate in the longitudinal direction thereof, parts of the light from the LED elements are refracted and scattered by the optical member and hence the light irradiation in the direction of an extension of the LED substrate in the longitudinal direction is enhanced, whereby the light distribution substantially over the entire peripheral direction is achieved. Therefore, control of the light distribution is achieved by changing the shape of the optical functional portions of the optical member as needed in accordance with the object. For example, a desired light distribution such as a light distribution equivalent to the general lighting incandescent filament lamp may be realized.

### BRIEF DESCRIPTION OF THE DRAWINGS

FIG. 1 is a perspective view illustrating a schematic configuration of an example of an LED bulb according to the invention:

FIG. 2 is a perspective view schematically illustrating a configuration of a light-emitting portion of the LED bulb illustrated in FIG. 1;

FIG. 3A is a drawing illustrating a configuration of the light-emitting portion of the LED bulb illustrated in FIG. 1 viewed from the outside of LED substrates in the longitudinal direction thereof;

FIG. 3B is a drawing illustrating a configuration of the light-emitting portion of the LED bulb illustrated in FIG. 1 viewed from a direction vertical to the LED substrates;

FIG. 4 is a drawing illustrating a configuration of an example of the LED substrate which constitutes the light-emitting portion;

FIG. 5 is a light distribution curve of an LED bulb manufactured in Experimental Example 1;

FIG. 6A is a drawing for explaining a method of measuring light distribution in the short-side direction of the LED substrates of LED bulbs manufactured in Experimental Example 1 and Comparative Experimental Example 1;

FIG. 6B is a drawing for explaining a method of measuring light distribution in the longitudinal directions of the LED substrates of the LED bulbs manufactured in Experimental Example 1 and Comparative Experimental Example 1;

FIG. 7 is a light distribution curve of an LED bulb manufactured in Comparative Experimental Example 1 for comparison;

FIG. 8A is a perspective view schematically illustrating another configuration of the light-emitting portion of the LED bulb of the invention;

FIG. 8B is a perspective view schematically illustrating still another configuration of the light-emitting portion of the LED bulb of the invention;

FIG. 8C is a perspective view schematically illustrating a further configuration of the light-emitting portion of the LED bulb of the invention;

FIG. 8D is a perspective view schematically illustrating a further configuration of the light-emitting portion of the LED bulb of the invention; and

FIG. 8E is a perspective view schematically illustrating a further configuration of the light-emitting portion of the LED bulb of the invention.

### DESCRIPTION OF THE PREFERRED EMBODIMENTS

An embodiment of the invention will be described in detail.

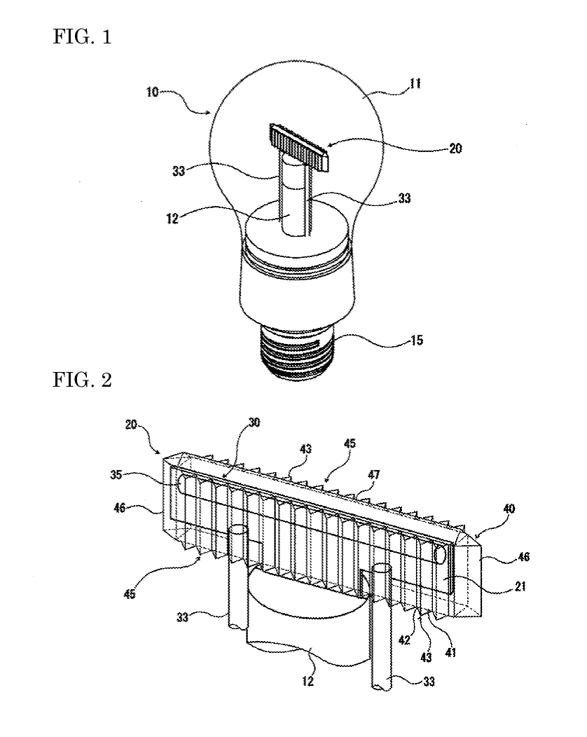

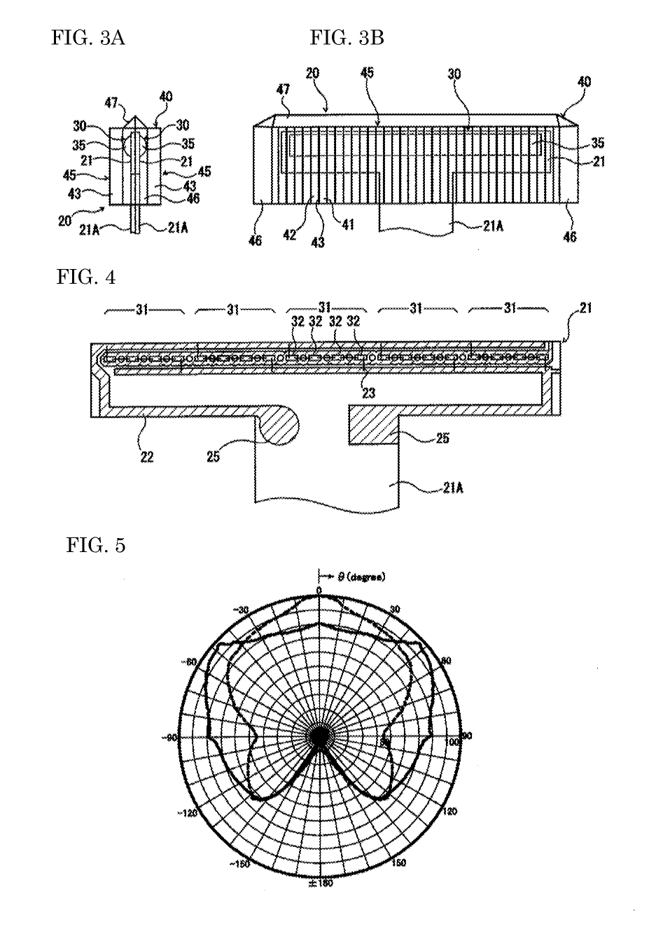

FIG. 1 is a perspective view illustrating a schematic configuration of an example of an LED bulb according to the invention. FIG. 2 is a perspective view schematically illustrating a configuration of a light-emitting portion of the LED bulb illustrated in FIG. 1. FIG. 3A is a drawing illustrating a configuration of the light-emitting portion of the LED bulb illustrated in FIG. 1 viewed from the outside of LED substrates in the longitudinal direction thereof and FIG. 3B is a drawing illustrating a configuration of the light-emitting portion of the LED bulb illustrated in FIG. 1 viewed from a direction vertical to the LED substrates. FIG. 4 is a drawing illustrating a configuration of an example of the LED substrate which constitutes the light-emitting portion.

An LED bulb 10 includes a substantially spherical shaped globe 11 having translucency and a base 15 provided at an end of the globe 11 and, for example, is formed to have the substantially same appearance as a general lighting bulb such as an incandescent filament lamp. A light-emitting portion having chip-type LED elements 32 (see FIG. 4) as light-emitting sources is provided at a center position in the interior of the globe 11. The globe 11, for example, is formed of transparent glass, opaque glass, or a transparent or milky white (like opaque glass) plastic material.

The light-emitting portion 20 in this example includes two LED modules 30 each including an LED substrate 21 (see FIG. 2) elongated in one direction, a plurality of the chip-type LED elements 32 (see FIG. 4) arranged on one of the surfaces of the LED substrates 21, and a half-cylindrically shaped mold member 35 configured to encapsulate a peripheral space of the LED elements 32. The two LED modules 30 are incorporated in an optical member (light-emitting member) 40 described later in a state in which the other surfaces of the LED substrates 21 face each other.

The light-emitting portion 20 is fixed such that plate-shaped fixed portions 21A provided on the LED substrates 21 (see FIG. 1) are fixed to a column-shaped light-emitting portion supporting member 12 with a screw and the like (not illustrated) in a position in which surfaces of the LED substrates 21 on which the LED elements 32 are provided (see FIG. 4) face sideways, for example.

In each of the LED module 30 illustrated in FIGS. 3A and 3B, for example, five LED element rows 31 each including four LED elements 32 connected to each other in series are mounted on the surface of the LED substrate 21 in parallel in the longitudinal direction of the LED substrate 21 as illustrated in FIG. 4.

Reference numeral 22 in FIG. 4 denotes a circuit pattern formed of copper (hatched in FIG. 4 for the sake of convenience), reference numeral 23 denotes a power feeding gold wire bonded on the circuit pattern 22, and reference numerals 25 denotes pads for connecting lead wires 33 for power feeding with soldering or the like.

The LED element 32 employed here is a LED element with its emitting light having a peak wavelength between 445 nm to 460 nm, for example. As the LED element, those having a configuration in which a nitride-based semiconductor layer laminated on a sapphire substrate, for example, may be used.

The mold member 35 is formed by mixing phosphor in transparent resin, and the phosphor is excited by light from the LED elements 32, whereby blue light emitted by the LED elements 32 is converted into light having a predetermined wavelength to be radiated.

Examples of a transparent material used for the mold member 35 include silicone resin and epoxy resin, for example.

Examples of a phosphorous material which may be used here include, for example, phosphorous materials (yellow phosphor) such as cerium-activated yttrium alumina phosphor (YAG), cerium-activated terbium alumina phosphor (TAG), alkali earths silicate phosphor (BOSS), and one of these materials may be used alone, or a plurality of types of those may be combined.

Therefore, in the LED bulb 10 described above, as described above, the LED modules 30 in the light-emitting portion 20 are incorporated in the optical member (light-radiating member) 40, and the optical member 40 includes optical functional portions 45 configured to direct the light in the longitudinal directions of the LED substrates 21.

The optical functional portions 45 of the optical member 40 as illustrated in FIG. 3 include, for example, first slant surfaces 41 inclined so that an extension thereof intersects the direction of one of extensions of the LED substrates 21 in the longitudinal direction thereof, and second slant surfaces 42 inclined so that an extension thereof intersects the direction of the other extension of the LED substrate in the longitudinal direction thereof, and are formed so as to face surfaces of the LED substrates 21 on which the LED elements 32 (see FIG. 4) are mounted. In other words, said optical functional portion 45 includes a first slant surface 41 and a second slant surface 42, wherein said first slant surface 41 is inclined so that an extension thereof intersects the longitudinal direction of the LED substrate 21 at a first angle, and said second slant surface 42 is inclined so that an extension thereof intersects the longitudinal direction of the LED substrate 21 at a second angle, that is different from the first angle.

Specifically, the optical member 40 in this example is formed with a plurality of triangular prism-shaped portions 43 each including the first slant surface 41 and the second slant surface 42 as two planes interposing an apex therebetween arranged on peripheral side surfaces of a parallelepiped mass member thereof each opposing the one surface of each of the LED substrates 21. The triangular prism-shaped portions 43 are formed so as to be arranged in the longitudinal direction of the LED substrates 21 along one of the surfaces thereof, and the optical functional portions 45 are formed by surfaces with projections and depressions formed of the plurality of triangular prism-shaped portions 43. Triangular prism shaped light-irradiation portions 46 are formed on both peripheral side surfaces of the mass member which constitutes the optical member 40 in the longitudinal directions of the LED substrates 21. Furthermore, a triangular prism shaped light-irradiation portion 47 is formed on an upper surface of the mass member so as to extend in the longitudinal direction of the LED substrates 21.

The optical member 40 is formed of a transparent or milky white resin. Examples of such resins which may be used here include those exemplified as materials which constitute the mold members 35 of the LED modules 30 (for example, silicone resin). By using the material of the same type in this manner, occurrence of refraction at interfaces of the LED modules 30 with respect to the mold members 35 and the optical member 40 is avoided.

In this manner, according to the LED bulb 10 having the configuration as described above, the LED modules 30 of the light-emitting portion 20 are configured by being incorporated into the optical member 40 having the optical functional portions 45 which cause light to direct in the direction of an extension of the LED substrates 21 in the longitudinal directions thereof. In this configuration, parts of light from the respective LED elements 32 are refracted and scattered by the first slant surfaces 41 and the second slant surfaces 42 of the optical functional portions 45 of the optical member 40. Owing to the refraction and scattering described above, the amount of light irradiating in the direction of an extension of the LED substrates 21 in the longitudinal direction thereof is enhanced as shown in the result of experimental example describe later, so that the light distribution over the substantially entire circumferential direction is achieved. Therefore, control of the light distribution is achieved by changing the shape of the optical functional portions 45 of the optical member 40 as needed in accordance with the object. For example, a desired light distribution such as a light distribution equivalent to the general lighting incandescent filament lamp may be achieved.

In addition, since the light-emitting portion 20 is arranged at a center of the LED bulb 10, the LED bulb 10 provides an advantage that the light emission similar to that of the conventional incandescent filament lamp in an ornamental viewpoint can be obtained.

Experimental examples performed for confirming the effect of the invention will be described below.

### Experimental Example 1

An LED bulb according to the invention was manufactured in accordance with the configuration illustrated in FIG. 1 to FIG. 4. The specifications of the LED bulb are shown below.

### LED Bulb Specification

### Light-Emitting Portion 20

LED substrate (21): entire length 24 mm, thickness 0.2 mm.

LED element (32): light-emitting wavelength 445 to 460 nm, power consumption 90 mW

The number of the LED modules (30) was two, the number of rows of the LED element rows in each of the LED module was five, and the number of the LED elements in each of the LED element rows was four (the number of the LED elements mounted on one of the LED substrates: 40),

Mold member (35): formed by mixing alkali-earth silicate phosphor (BOSS, light-emitting wavelength: 515 to 610 nm) as a phosphorous material into silicone resin, thickness (maximum): 0.64 mm,

Optical Member (40): entire length (the distance between apexes of the light-irradiating portions 46 in the longitudinal direction of the LED substrate) was 27.9 mm, thickness (the distance from an apex of the triangular prism-shaped portion on one of the peripheral side surfaces to an apex of the triangular prism-shaped portion on the other peripheral side surface) was 4.35 mm, the number of the triangular prism-shaped portions which constitute the optical functional portion on one of the peripheral side surfaces is 17, the distance between the adjacent triangular prism-shaped portions which constitute the optical functional portion (the distance between apexes) was 1.48 mm, and the angle of the apex of the triangular prism-shaped portion which constitutes the optical functional portion and the light-irradiating portion was 60 degrees.

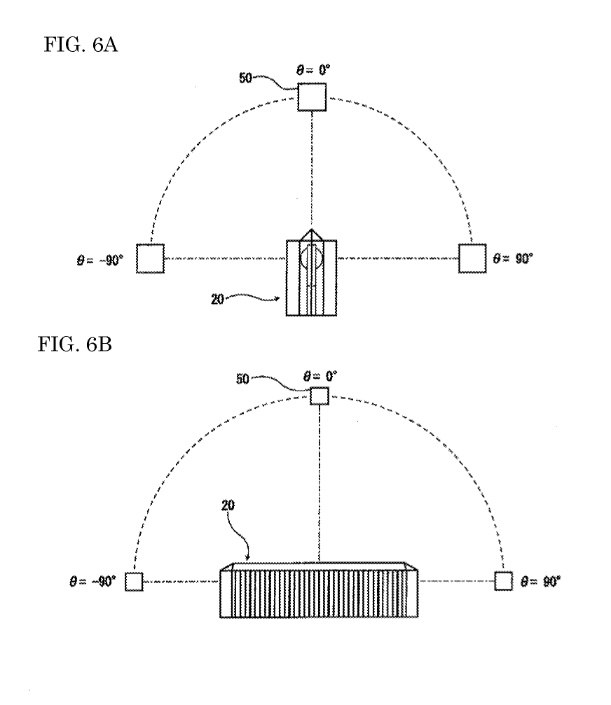

When the light distribution of the LED bulb was measured, a light distribution curve as illustrated in FIG. 5 was obtained. In FIG. 5, a light distribution curve illustrated in a solid line (hereinafter, referred to as “light distribution curve in the short-side direction”) was measured by moving (rotating) a detector (sensor) 50 arranged at a position apart from a certain distance from the light-emitting portion 20 extending along an arc having a center at the light-emitting portion 20 about an axis (an axis vertical to the paper surface) extending in the longitudinal direction of the LED substrate as illustrated in FIG. 6A. The light distribution curve was obtained by plotting light intensities at a predetermined angle position θ by the measurement, and is indicated by relative values with respect to the maximum intensity value. A light distribution curve illustrated in a broken line (hereinafter, referred to as “light distribution curve in the longitudinal direction”) was measured by moving (rotating) the detector (sensor) 50 arranged at a position apart from a certain distance from the light-emitting portion 20 extending along an arc having a center at the light-emitting portion 20 about an axis (an axis vertical to the paper surface) extending vertical to the LED substrate as illustrated in FIG. 6B. The light distribution curve was obtained by plotting light intensities at the predetermined angle position θ by the measurement, and is indicated by relative values with respect to the maximum intensity value.

### Comparative Experimental Example 1

In the LED bulb manufactured in Experimental Example 1, an LED bulb for comparison having the same configuration as the LED bulb relating to Experimental Example 1 except for a configuration in which the optical member (40) in the invention is not provided as the light-emitting portion was manufactured.

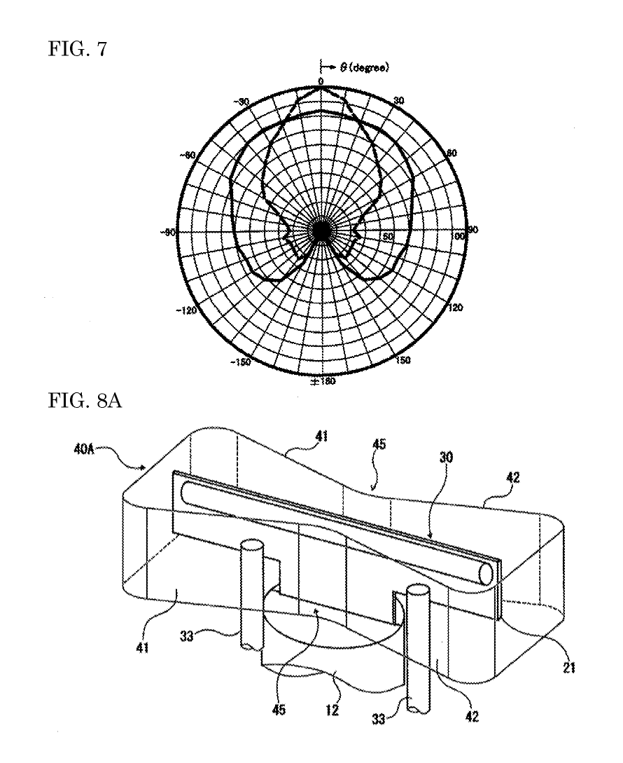

When the light distribution of the LED bulb was measured in the same manner as Experimental Example 1 for the LED bulb for comparison, a light distribution curve as illustrated in FIG. 7 was obtained. In FIG. 7, a light distribution curve illustrated by a solid line was a light distribution curve in the short-side direction, and a light distribution curve illustrated by a broken line is a light distribution curve in the longitudinal direction.

As apparent from a result as described above, it was confirmed that according to the LED bulb of the invention, the intensity of light irradiating in the direction of an extension of the LED substrate in the longitudinal direction thereof and the light irradiating in the direction of downward extension of the LED substrate in the short-side direction is enhanced and hence the light distribution in the direction of the entire circumference except for a portion hidden by the base is achieved in comparison with the LED bulb for comparison.

Although the embodiment has been described thus far, the invention is not limited to the embodiment described above, and various modifications may be made.

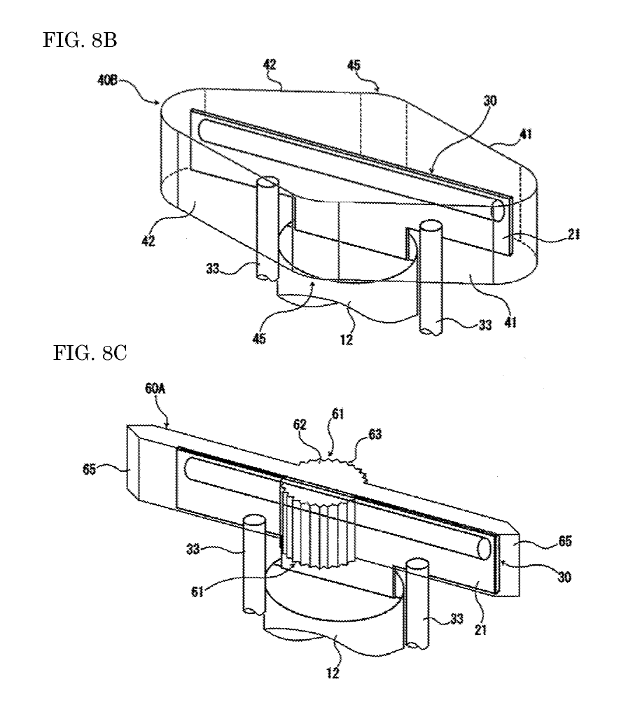

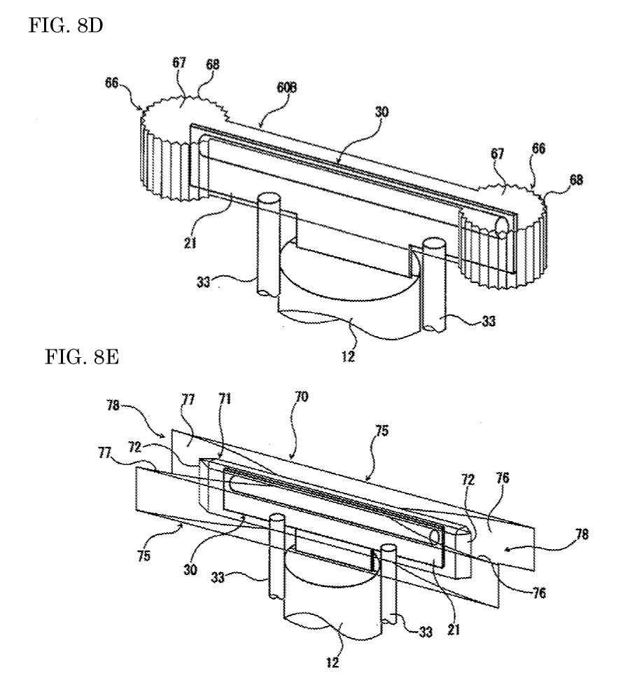

For example, the shape of the optical member which constitutes the light-emitting portion is not limited to that according to the embodiment described above. For example, the same effect as described above may be obtained even those having the shapes illustrated in FIG. 8A, FIG. 8b, FIG. 8C, FIG. 8D and FIG. 8E, or a configuration in which the projections and depressions formed of the first slant surfaces and the second slant surfaces are formed on the upper surface thereby forming the optical functional portion.

An optical member 40A in FIG. 8A has a form in which peripheral side surfaces of a parallelepiped mass member facing the surfaces of the LED substrates 21 on which the LED elements are mounted form the first slant surfaces 41 and the second slant surfaces 42 which constitute the optical functional portions 45 and extend from the central portions in the longitudinal direction toward the end portions thereof.

An optical member 40B illustrated in FIG. 8B is a mass member having a substantially diamond shape in cross section taken along a plane vertical to the LED substrates 21, and two peripheral side surfaces interposing apexes therebetween and facing the surfaces of each of the LED substrates 21 on which the LED elements are mounted constitute the first slant surfaces 41 and the second slant surfaces 42 which constitute the optical functional portions 45.

An optical member 60A illustrated in FIG. 8C is formed with half-cylindrical shaped bulged portions 62 extending in the short-side direction of the LED substrates 21 at center positions in the longitudinal direction of the peripheral side surfaces of the parallelepiped mass member facing one of the surfaces of each of the LED substrates 21, and includes optical functional portions 61 formed with a plurality of triangular prism-shaped portions 63 so as to be arranged along the peripheral surfaces of the bulged portions 62. Triangle prism shaped light-irradiating portions 65 projecting in the outward directions in the longitudinal direction are also formed on peripheral side surfaces of the mass member on both sides thereof in the longitudinal direction of the LED substrates 21.

An optical member 60B illustrated in FIG. 8D is formed with cylindrical shaped bulged portions 67 extending in the short-side direction of the LED substrates 21 at both end positions in the longitudinal direction thereof on the parallelepiped mass member, and includes optical functional portions 66 formed with a plurality of triangular prism-shaped portions 68 so as to be arranged along the peripheral surfaces of the bulged portions 67.

An optical member 70 illustrated in FIG. 8E includes a base portion 71 formed with triangular prism shaped light-irradiating portions 72 on peripheral side surfaces of the parallelepiped mass member in the longitudinal direction of the LED substrates 21, and column shaped functional portions 75 formed continuously from the respective peripheral side surfaces of the base portion 71 opposing one of the surfaces of each of the LED substrates 21. One end portion of each of the functional portions 75 in the longitudinal direction thereof has an slant surface inclined so that an extension thereof intersects one of extensions of the LED substrate in the longitudinal direction thereof, and is formed so as to have a first slant surface 76 having a cross-section taken along the direction vertical to the LED substrates 21 has a parabolic shape. In contrast, the other end portion of each of the functional portions 75 in the longitudinal direction thereof has an slant surface inclined so that an extension thereof intersects the direction of the other extension in the longitudinal direction thereof, and is formed so as to have a second slant surface 77 having a cross-section taken along the direction vertical to the LED substrates 21 has a parabolic shape. Then, the end portions of the base portion 71 are positioned so as to be interposed between the slant surfaces of the functional portions 75. In this optical member 70, the first slant surfaces 76 and the second slant surfaces 77 of the functional portions 75 are formed as reflecting surfaces, whereby an optical functional portion 78 is formed.

The LED module may have a configuration in which a plurality of LED elements are arranged on each of the both surfaces of the one of the LED substrates and, alternatively, near-ultraviolet light-emitting LED elements may be used as the LED elements.

Furthermore, a configuration in which a phosphor film is formed on the inner surface of the globe is also applicable. In such a configuration, it is not necessary to provide a mold member configured to encapsulate the peripheral space of the LED elements.

What is claimed is:

1. An LED bulb comprising:
an optical member;
a light-emitting portion including:
an LED module incorporated in the optical member, said LED module having:
an LED substrate elongated in its longitudinal direction; and
a plurality of LED elements, as light-emitting sources, arranged on at least one of surfaces of the LED substrate so as to be arrayed in the elongated direction of the LED substrate;
wherein said optical member includes an optical functional portion configured to direct light in the longitudinal direction of the LED substrate.

2. The LED bulb according to claim 1, wherein the optical functional portion of the optical member is formed so as to face a surface of the LED substrate on which the LED elements are mounted, and said optical functional portion includes a first slant surface and a second slant surface, wherein said first slant surface inclined so that an extension thereof intersects the longitudinal direction of the LED substrate at a first angle, and said second slant surface inclined so that an extension thereof intersects the longitudinal direction of the LED substrate at a second angle.

3. The LED bulb according to claim 2, wherein the optical functional portion of the optical member is formed with a plurality of the triangular prism-shaped portions each having two planes interposing an apex therebetween, the two planes being the first slant surface and the second slant surface, and the plurality of triangular prism-shaped portions being arranged in the longitudinal direction of the LED substrate.

4. The LED bulb according to claim 1, wherein the light-emitting portion includes two LED modules each including the LED substrate having a plurality of LED elements arranged on one surface thereof, and the two LED modules are arranged with the other surfaces of the LED substrates facing each other.

5. The LED bulb according to claim 1, wherein the LED module includes the plurality of LED elements arranged on each of both surfaces of the LED substrate.
